(19) United States
(12) Patent Application Publication
(10) Pub. No.: US 2021/0170833 A1
(43) Pub. Date: Jun. 10, 2021

(54) DEBRIS SHIELD FOR AN AIR CONDITIONER UNIT

(71) Applicant: Haier US Appliace Solutions, Inc., Wilmington, DE (US)

(72) Inventors: Richard Dustin Henderson, La Grange, KY (US); Eric Ormsby Sakal, Louisville, KY (US)

(21) Appl. No.: 16/702,814

(22) Filed: Dec. 4, 2019

(51) Int. Cl. B60H 3/06; B60H 1/00; B60H 1/24; B60H 1/26

(52) U.S. Cl. CPC B60H 3/0658; B60H 1/00371; B60H 2001/00235; B60H 1/262; B60H 1/245

(57) ABSTRACT

A recreational vehicle air conditioner includes an indoor cover defining an indoor air plenum, an outdoor air plenum, and a shaft aperture. An indoor fan is positioned within the indoor air plenum, a drive motor is positioned in the outdoor air plenum, and the indoor fan and the drive motor are coupled by a drive shaft that passes through the shaft aperture. A debris shield, such as an annular rubber washer, is positioned around the drive shaft within the outdoor air plenum for blocking debris from passing through the shaft aperture.

### FIELD OF THE INVENTION

The present subject matter relates generally to air conditioners in recreational vehicles, and more particularly, to debris shields for preventing outside debris from passing into an indoor portion of the air conditioner unit.

### BACKGROUND OF THE INVENTION

Certain recreational vehicles include an air conditioning system, referred to generally as a recreational vehicle air conditioner (RVAC), for maintaining a comfortable temperature within the passenger compartment. The air conditioning units are typically mounted on the roof or another exterior location of the recreational vehicle and utilize a sealed system for circulation refrigerant between an indoor and outdoor heat exchanger to facilitate heat transfer. For example, the indoor heat exchanger is positioned within an indoor portion of the RVAC and is in fluid communication with the passenger compartment through an opening in the roof. The outdoor heat exchanger is positioned within the outdoor portion and is separated from the indoor heat exchanger by a partition or divider.

Conventional RVACs include an indoor fan or blower for circulating a flow of air through the indoor heat exchanger. It is common to mount the motor for driving the indoor blower in the outdoor portion, e.g., to reduce noise within the passenger compartment. However, mounting the motor outside requires that a drive shaft pass through the partition that divides the indoor portion from the outdoor portion, introducing an air leak point and a path through which debris may enter the indoor portion. In this regard, when the indoor blower is operating and thus generating a negative pressure within the indoor portion, debris may tend to be drawn into the indoor portion through the hole in the partition.

Accordingly, an improved air conditioner unit would be useful. More specifically, a recreational vehicle air conditioner with an indoor blower driven by an outdoor motor and features for reducing the intake of debris or contaminants into the indoor portion would be particularly beneficial.

### BRIEF DESCRIPTION OF THE INVENTION

Aspects and advantages of the invention will be set forth in part in the following description, or may be apparent from the description, or may be learned through practice of the invention.

In accordance with one exemplary embodiment of the present disclosure, a recreational vehicle air conditioner is provided including an indoor cover defining an indoor air plenum, an outdoor air plenum, and a shaft aperture. An indoor fan is positioned within the indoor air plenum for urging a flow of indoor air through the indoor air plenum, a drive shaft is mechanically coupled to the indoor fan and passing through the shaft aperture into the outdoor air plenum, a drive motor is mechanically coupled to the drive shaft for selectively rotating the indoor fan, and a debris shield is positioned around the drive shaft for blocking debris from passing through the shaft aperture.

In accordance with another exemplary embodiment of the present disclosure, a fan assembly for an air conditioner unit is provided. The air conditioner unit includes an indoor cover defining an indoor air plenum, an outdoor air plenum, and a shaft aperture. The fan assembly includes an indoor fan positioned within the indoor air plenum for urging a flow of indoor air through the indoor air plenum, a drive shaft mechanically coupled to the indoor fan and passing through the shaft aperture into the outdoor air plenum, and a debris shield positioned around the drive shaft for blocking debris from passing through the shaft aperture.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a recreational vehicle according to an exemplary embodiment of the present disclosure.

FIG. 2 provides a perspective view of a recreational vehicle air conditioner (RVAC) that may be used with the exemplary recreational vehicle of FIG. 1, with an outdoor cover removed for clarity.

FIG. 3 provides a perspective view of the exemplary RVAC of FIG. 2 with an indoor cover removed for clarity.

FIG. 4 provides a top view of the exemplary RVAC of FIG. 2 with an indoor cover removed for clarity.

FIG. 5 provides a schematic view of an air conditioning system according to an exemplary embodiment of the present disclosure.

FIG. 6 provides a schematic side view of the exemplary RVAC of FIG. 2.

FIG. 7 provides a schematic cross-sectional view of a drive shaft and debris shield according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. In addition, as used herein, terms of approximation, such as “approximately,” “substantially,” or “about,” refer to being within a ten percent margin of error.

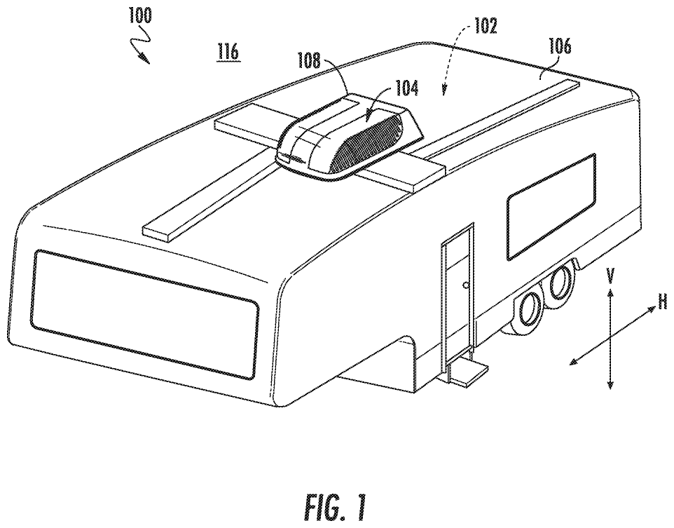

FIG. 1 provides a perspective view of an exemplary recreational vehicle 100 in accordance with the present disclosure. People may employ recreational vehicle 100 for a variety of purposes, including transportation, cooking, eating, sleeping, entertaining, and the like. As such, recreational vehicle 100 defines a passenger compartment 102, which may further include a bed, stove, table, restroom, or multiple compartments for storing items that passengers wish to take with them on their travels. Because people often spend significant time within the passenger compartment of recreational vehicle 100, climate control of the passenger compartment is desirable.

Accordingly, an air conditioning system 104 may be mounted on recreational vehicle 100 to provide cooled air to the passenger compartment. Air conditioning system 104 is typically mounted to an outside surface 106 of recreational vehicle 100. This arrangement is desirable because a byproduct of operation of air conditioning system 104 is heated air, which has been passed over a heat exchanger to remove heat from the air circulating within passenger compartment 102. During certain operations, this heated air may be exhausted to the ambient air. As shown in the exemplary embodiment of FIG. 1, air conditioning system 104 may be mounted on an outer surface 106, such as the ceiling or top of recreational vehicle 100. Also as shown in FIG. 1, air conditioning system 104 may include a top cover or outer grill 108 that is positioned over the working components air conditioning system 104, e.g., to protect such working components from rain, wind, debris, etc.

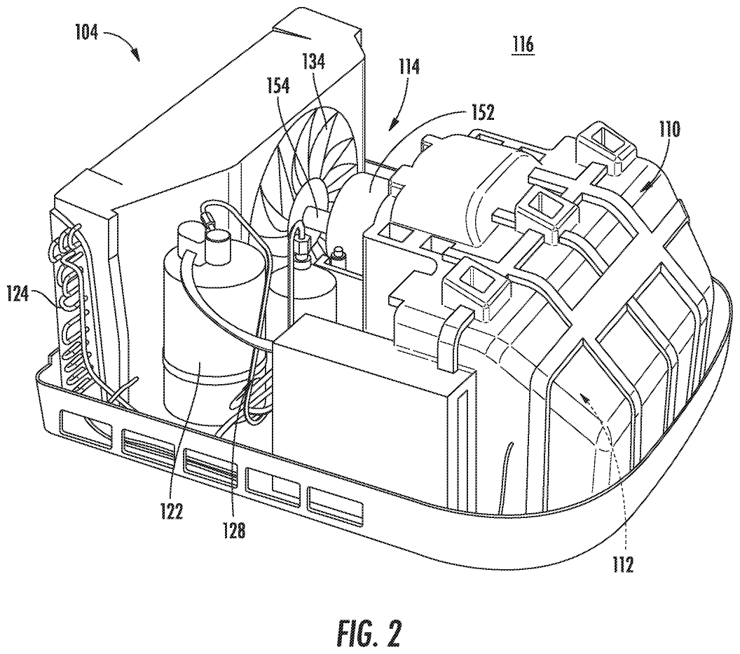

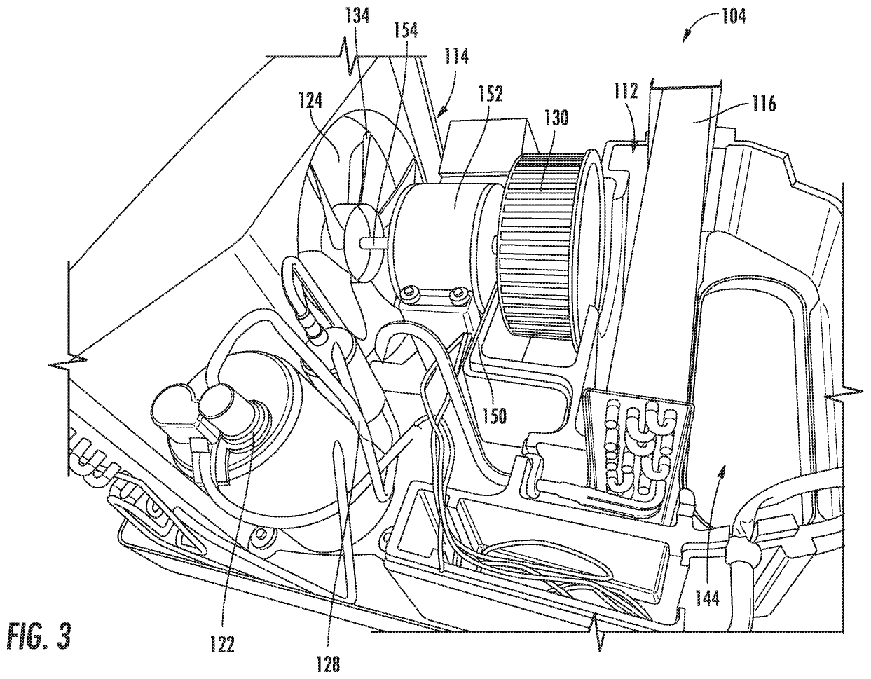

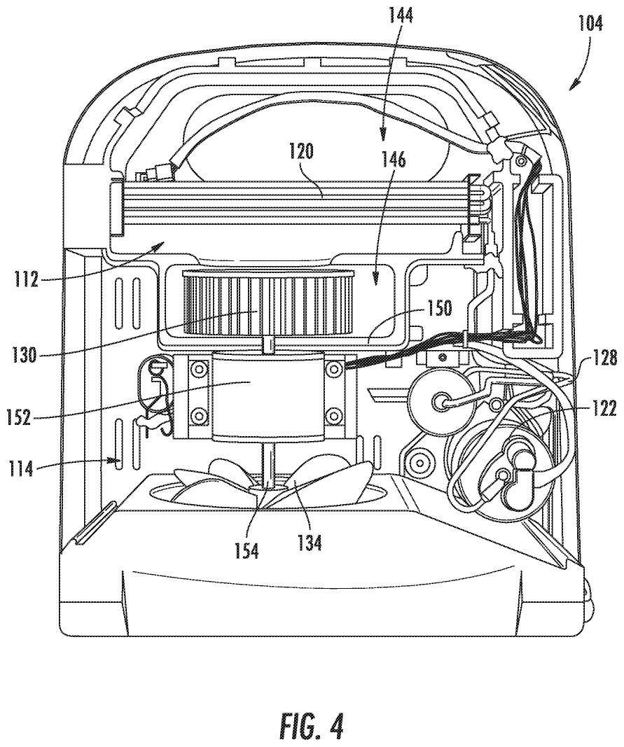

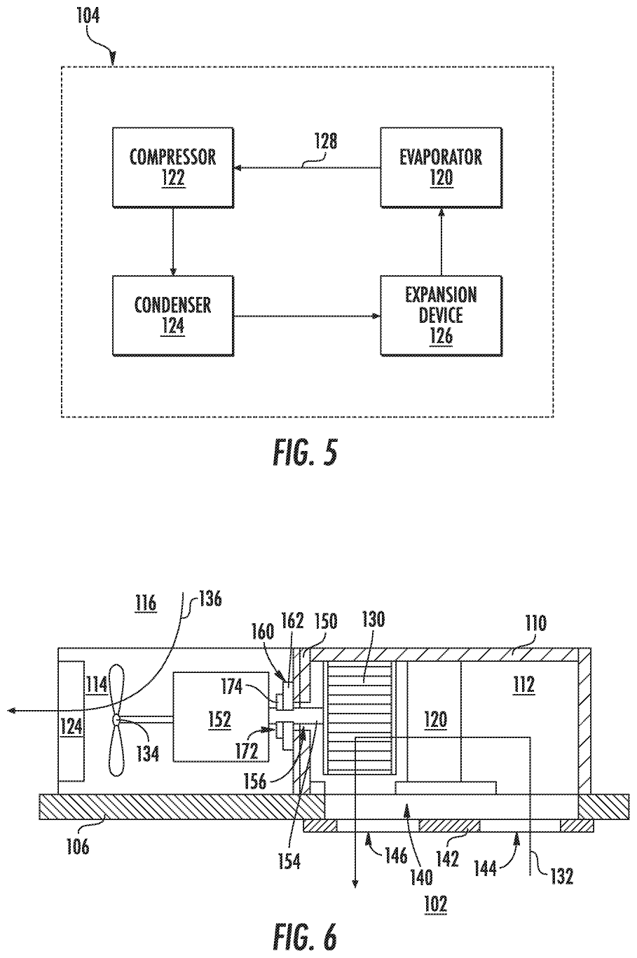

Referring now generally to FIGS. 2 through 6, the operation of air conditioning system 104 will be described in more detail according to exemplary embodiments of the present subject matter. As illustrated, outer grill 108 has been removed to reveal working components of air conditioning system 104. Air conditioning system 104 generally includes an indoor bulkhead for indoor cover 110 that divides air conditioning system 104 between an indoor and outdoor portion, such as in a packaged terminal air conditioner unit (PTAC) or a split heat pump system. Specifically, indoor cover 110 defines and indoor air plenum 112 and an outdoor air plenum 114. In this regard, as shown in FIGS. 2 and 6, indoor cover 110 generally shields the indoor components of air conditioning system 104 from the outdoor environment 116. As shown in FIGS. 3 and 4, indoor cover 110 is removed to reveal additional working components of air conditioning system 104, each of which will be described below in detail.

Referring now generally to FIGS. 2 through 6, relevant components of air conditioning system 104 will be described. It will be understood that air conditioning system 104 includes various heat pump components, such as a sealed system, for treating air within an interior of an associated recreational vehicle 100. Such components are well understood by those skilled in the art and a description of such components is omitted for the sake of brevity. In this regard, for example, air conditioning system 104 includes refrigerant circulating between evaporator 120, compressor 122, condenser 124, and expansion device 126, as shown in the refrigeration loop 128 of air conditioning system 104 in FIG. 2. Refrigerant, also known as coolant, carries heat from the passenger compartment 102 of recreational vehicle 100 to the outdoors 116 (e.g., ambient area surrounding outer surface 106 of the passenger compartment 102). Refrigerant is useful because it changes states from a liquid to a vapor at convenient temperatures for a refrigeration cycle. One suitable refrigerant for use in refrigeration loop 128 is 1,1,1,2-Tetrafluoroethane, also known as R-134A, although it should be understood that the present disclosure is not limited to such example and that any suitable refrigerant may be utilized.

The refrigerant begins by passing through evaporator 120 in liquid form. Ambient air or air from the passenger compartment 102 may pass over evaporator 120, e.g., as motivated by an evaporator air handler. More specifically, as illustrated, air conditioner system 104 may include an indoor fan 130 configured for urging a flow of indoor air (e.g., as identified by reference numeral 132 in FIG. 6). Because the liquid refrigerant is cold in this low-pressure state, it absorbs heat from the air passed over it, cooling the air for delivery to the passenger compartment 102. As the liquid refrigerant absorbs heat, it evaporates into a vapor. From there, the gaseous refrigerant is delivered to compressor 122, which increases the pressure of the refrigerant, thus raising its temperature well-above the ambient temperature outside of recreational vehicle 100. From compressor 122, the heated refrigerant is delivered to condenser 124. Air may pass over condenser 124, e.g., as motivated from a condenser air handler. More specifically, as illustrated, air conditioning system 104 may include an outdoor fan 134 configured for urging a flow of outdoor air (e.g., as identified by reference numeral 136 in FIG. 6), thereby facilitating heat transfer from the heated refrigerant to the ambient air. In releasing this heat energy, the refrigerant condenses back into liquid form. Next, the refrigerant is delivered to expansion device 126, where the pressure of the refrigerant is reduced, thus decreasing its temperature. The cooled, liquid refrigerant is then delivered back to evaporator 120 to repeat the process.

In order to transport cooled air from the air conditioning system 104 on an outside surface 106 of recreational vehicle 100 to the passenger compartment 102 on the inside of recreational vehicle 100, outer surface 106 may define an opening 140 that is in fluid communication with indoor air plenum 112. In addition, air conditioning system 104 may include a ceiling-mount cover panel 142 that may be mounted on a ceiling within an interior of an associated recreational vehicle. Cover panel 142 may overlay and hide components of air conditioning system 104 to provide a pleasant cosmetic appearance for air conditioning system 104. Cover panel 142 may also include perforated sections to allow the flow of outdoor air 132 through cover panel 142.

For example, cover panel 142 may include an air inlet 144 and an air outlet 146. Air inlet and outlets 144, 146 may be separate from each other on cover panel 142. Air from within the interior of the associated recreational vehicle may flow through cover panel 142 via air inlet 144, and such air may be treated (e.g., heated or cooled) by a sealed system of air conditioning system 104, and the treated air may then flow back into the interior of the associated recreational vehicle through cover panel 142 via air outlet 146. Cover panel 142 may also include a removable filter cover (not shown) mounted to cover panel 142 and being perforated to allow air flow through the filter cover. For example, the filter cover may support or hold a filter medium, such as a concertinaed or pleated fabric filter, fiberglass filter, etc., that filters air entering air conditioning system 104 at air inlet 144.

As shown, indoor fan 130 is positioned within indoor air plenum 112, e.g., adjacent a vertical bulkhead 150 which is part of indoor cover 110. According to the illustrated embodiment, a fan drive motor 152 is positioned outside of indoor air plenum 112, e.g., within outdoor air plenum 114. This may be advantageous, for example, to cool drive motor 152 by permitting the flow of outdoor air 136 to pass over drive motor 152, to reduce noise within passenger compartment 102, or for a variety of other reasons. Notably, however, mounting drive motor 152 outside of indoor air plenum 112 requires a drive shaft 154 to pass through indoor cover 110 in order to mechanically coupled with indoor fan 130.

Specifically, according to the illustrated embodiment, indoor cover 110, or more specifically vertical bulkhead 150 defines a shaft aperture 156 through which drive shaft 154 may pass from outdoor air plenum 114 into indoor air plenum 112. Specifically, drive shaft 154 mechanically couples drive motor 152 which is positioned in outdoor air plenum 114 with indoor fan 130 which is positioned within indoor air plenum 112. Notably, however, shaft aperture 156 may provide a passageway through which outdoor debris or unconditioned air may enter into indoor air plenum 112. In this regard, specifically when indoor fan 130 is operating and creating a negative pressure within indoor air plenum 112, dirt and debris may have a tendency to be drawn into indoor air plenum 112. Aspects of the present subject matter are directed towards features for reducing or eliminating the passage of such debris into indoor air plenum 112.

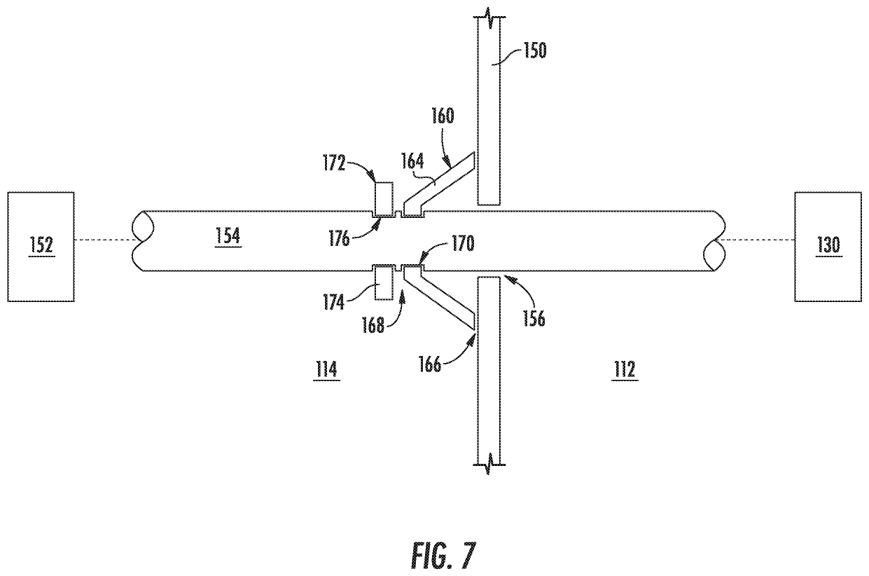

Specifically, according to exemplary embodiments, air conditioning system 104 may include a debris shield 160 that is positioned around the drive shaft 154 for blocking debris from passing through shaft aperture 156. Debris shield 160 may generally be any suitable device or structure that has a tendency to block shaft aperture 156 for preventing the flow of debris into indoor air plenum 112. For example, according to the exemplary embodiment illustrated in FIG. 6, debris shield 160 may be an annular disc or washer 162. According to alternative embodiments, debris shield 160 may have any other suitable size, shape, geometry, position, and configuration. For example, according to the exemplary embodiment illustrated in FIG. 7, debris shield 160 is a conical washer 164 that tapers from a wide end 166 toward a narrow end 168. Specifically, as illustrated, wide end 166 is positioned adjacent indoor cover 110 or over shaft aperture 156, while narrow end 168 extends toward drive motor 152.

Debris shield 160 may be constructed from any suitable material or combination of materials. For example, according to exemplary embodiments, debris shield 160 is made from rubber. According to alternative embodiments, debris shield 160 may be made from a polymer material, plastics, metals, fabrics, or any other suitable material or composition. In addition, although debris shield 160 is illustrated as having a substantially smooth surface, it should be appreciated that debris shield 160 may further include surface features such as ridges or bumps for facilitating debris removal, shedding, or movement. Other debris shields 160 are possible and within scope of the present subject matter.

According to the illustrated embodiment, debris shield 160 is mounted within outdoor air plenum 114, e.g., directly to drive shaft 154 such that it rotates with drive shaft 154. However, it should be appreciated that according to alternative embodiments, debris shield 160 may alternatively be mounted directly to indoor cover 110, e.g., such that it does not rotate with drive shaft 154. According to the illustrated embodiment, drive shaft 154 extends substantially along a horizontal direction H and is operably coupled to both indoor fan 130 and outdoor fan 134. In this regard, drive motor 152 may be positioned between the indoor fan 130 and outdoor fan 134 for selectively rotating both during an operating cycle of air conditioning system 104. It should be appreciated that according to alternative embodiments, outdoor fan 134 may include a dedicated motor. It should be further appreciated that air conditioning system 104 and refrigeration loop 128 may include additional or alternative components for facilitating a heating or cooling cycle.

According to exemplary embodiments, drive shaft 154 and/or debris shield 160 may include features for positioning debris shield 160 at the desired location or locking debris shield 160 in a particular position. For example, as best shown in FIG. 7, drive shaft 154 may define a locating groove 170 that is configured for receiving a portion of debris shield 160 to locate debris shield 160 at the desired axial location along drive shaft 154. In addition, a locking mechanism 172 may be mounted to drive shaft 154 for locking debris shield 160 in position. Specifically, according to the illustrated embodiment, locking mechanism 172 is a clip 174 that snaps into a locking groove 176 defined on drive shaft 154. It should be appreciated that any other suitable locking mechanism 172 may be used according to alternative embodiments. For example, locking mechanism 172 may include a lock washer, a set screw, a clamping member, or any other suitable locking mechanism or device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A recreational vehicle air conditioner comprising:
an indoor cover defining an indoor air plenum, an outdoor air plenum, and a shaft aperture;
an indoor fan positioned within the indoor air plenum for urging a flow of indoor air through the indoor air plenum;
a drive shaft mechanically coupled to the indoor fan and passing through the shaft aperture into the outdoor air plenum;
a drive motor mechanically coupled to the drive shaft for selectively rotating the indoor fan; and
a debris shield positioned around the drive shaft for blocking debris from passing through the shaft aperture.

2. The recreational vehicle air conditioner of claim 1, wherein the debris shield is mounted directly to the drive shaft and rotates with the drive shaft.

3. The recreational vehicle air conditioner of claim 1, wherein the debris shield is mounted to the indoor cover.

4. The recreational vehicle air conditioner of claim 1, wherein the debris shield is an annular disc.

5. The recreational vehicle air conditioner of claim 1, wherein the debris shield has a conical shape that tapers away from the shaft aperture.

6. The recreational vehicle air conditioner of claim 1, wherein the drive shaft defines a locating groove for locating the debris shield.

7. The recreational vehicle air conditioner of claim 1, further comprising:
a locking mechanism mounted to the drive shaft for locking the debris shield in position.

8. The recreational vehicle air conditioner of claim 7, wherein the locking mechanism is a clip that snaps into a locking groove defined on the drive shaft.

9. The recreational vehicle air conditioner of claim 1, wherein the drive shaft extends substantially along a horizontal direction.

10. The recreational vehicle air conditioner of claim 1, wherein the debris shield is mounted within the outdoor air plenum.

11. The recreational vehicle air conditioner of claim 1, wherein the debris shield is made from rubber.

12. The recreational vehicle air conditioner of claim 1, further comprising:
an outdoor fan positioned within the outdoor portion for urging a flow of outdoor air through the outdoor air plenum, wherein the drive shaft is operably coupled to the outdoor fan for selectively rotating the outdoor fan.

13. The recreational vehicle of claim 12, wherein the drive motor is positioned between the outdoor fan and the indoor fan.

14. The recreational vehicle air conditioner of claim 1, wherein the indoor fan is positioned adjacent the shaft aperture downstream of an indoor heat exchanger.

15. A fan assembly for an air conditioner unit, the air conditioner unit comprising an indoor cover defining an indoor air plenum, an outdoor air plenum, and a shaft aperture, the fan assembly comprising:
an indoor fan positioned within the indoor air plenum for urging a flow of indoor air through the indoor air plenum;
a drive shaft mechanically coupled to the indoor fan and passing through the shaft aperture into the outdoor air plenum; and
a debris shield positioned around the drive shaft for blocking debris from passing through the shaft aperture.

16. The fan assembly of claim 15, wherein the debris shield is mounted directly to the drive shaft and rotates with the drive shaft.

17. The fan assembly of claim 15, wherein the debris shield is an annular disc.

18. The fan assembly of claim 15, wherein the debris shield has a conical shape that tapers away from the shaft aperture.

19. The fan assembly of claim 15, wherein the drive shaft defines a locating groove for locating the debris shield.

20. The fan assembly of claim 15, further comprising:
a locking mechanism mounted to the drive shaft for locking the debris shield in position.
